(19) United States
(12) Patent Application Publication
(10) Pub. No.: US 2020/0391058 A1
(43) Pub. Date: Dec. 17, 2020

(54) FIRE EXTINGUISHING BOMB AND LAUNCHING SYSTEM THEREOF

(71) Applicant: Chunxia CHEN, Shanghai (CN)

(72) Inventor: Chunxia CHEN, Shanghai (CN)

(21) Appl. No.: 16/771,709

(22) PCT Filed: Dec. 6, 2018
(86) PCT No.: PCT/CN2018/119435

§ 371 Date: Jun. 11, 2020

(30) Foreign Application Priority Data
Dec. 11, 2017 (CN) 201721712107.4

(51) Int. Cl. A62C 3/02

(52) U.S. Cl. CPC A62C 3/025

(57) ABSTRACT

A fire extinguishing bomb and a launching system thereof are provided. The fire extinguishing bomb includes a fire extinguishing part and a propelling part connected to each other; the propelling part includes a storage bunker filled with liquid or fire extinguishing agent; the liquid or fire extinguishing agent is driven by compressing the volume of the storage bunker or compressing the volume of the liquid or the fire extinguishing agent and thus is sprayed out of the propelling part through a spray nozzle of the storage bunker, so that the fire extinguishing bomb obtains forward propulsion. The propelling part further includes an expansion part, and the expansion part comprises a power source component and a piston. The fire extinguishing part includes a fuze. The fire extinguishing bomb is ignited in the air after falling due to gravity, which minimizes the impact and interference to unmanned aircraft vehicle.

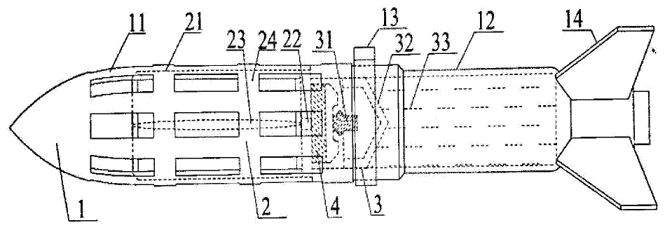

### CROSS REFERENCE TO THE RELATED APPLICATIONS

This application is the national phase entry of International Application No. PCT/CN2018/119435, filed on Dec. 6, 2018, which is based upon and claims priority to Chinese Patent Application No. 201721712107.4, filed on Dec. 11, 2017, the entire contents of which are incorporated herein by reference.

### TECHNICAL FIELD

The present invention relates to the field of fire safety, and more particularly to a fire extinguishing bomb and a launching system thereof.

### BACKGROUND

Fire safety has always been the focus of people's livelihood. It is not only related to huge property losses but also to safety of people's lives. Besides, fire extinguishment is a very dangerous operation, which poses a great threat to personal safety of firefighters.

Since reform and opening up launched in China, there are a large number of high-rise buildings, but most of fire trucks equipped by urban fire brigades could only reach places below 50 meters, which are useless to high-rise buildings over 100 meters. At the same time, due to the popularity of private cars, road congestion is becoming more and more serious, thus it is difficult for the fire trucks to implement rapid rescue. In other extreme situations, such as marine fire extinguishment, forest fire extinguishment, fire extinguishment for arsenal and nuclear power plant, the conventional ground rescue methods have limitations. Besides, huge challenges are posed to personal safety of firefighters.

In addition to conventional fire extinguishing equipment, various types of fire extinguishing systems are available on the market. However, these fire extinguishing systems are manufactured based on ground spraying or ground launching principles, in which ground equipment or personnel approach fire sources to spray fire extinguishing agent, throw or launch fire bombs for fire extinguishment. While, considering factors such as personal safety, convenient and fast transportation, limited space activity and projection accuracy, the fire extinguishing systems in the prior art are not flexible enough for fire rescue in urgent, difficult and dangerous situations and are not be completely applicable as well.

In recent years, unmanned aerial vehicles (UAVs) have become increasingly popular. The unmanned aerial vehicles carry fire extinguishing bombs for fire extinguishing operations, which has huge advantages. A cluster of unmanned aerial vehicles carry a large number of fire extinguishing bombs, reach to places close to the fire source, and carry out coordinated fire extinguishing operations. The unmanned aerial vehicles can be used for performing fire extinguishing operation on fire sources in special areas in a way of cluster collaboration and integrated reconnaissance. Thus, it is very flexible and suitable for fire extinguishing operations in all kinds of urgent, difficult and dangerous situations, especially suitable for fire extinguishing operations in urban high-rise buildings.

However, carrying fire extinguishing bombs by using UAVs is different from ground launching the fire extinguishing bombs, which has its own inherent weaknesses. If the fire extinguishing bombs are propelled by a missile-like gunpowder or if the fire extinguishing bombs are launched by a launching method for mortar, the following problems will arise: first, tail flame generated by the gunpowder propelling method will destroy the UAVs, and meanwhile, the after-flame and high-temperature gas generated by the gunpowder for engine on the missile may become a secondary fire source, and thus becoming new hidden dangers; second, the recoil generated by the launching method for mortar will have significantly impact the stability of the UAVs. In order to ensure the stability of the UAVs, performance of a power system will be restricted accordingly, and then the size and range of the fire extinguishing bomb will be restricted, i.e. there may be mutual constraints and contradictions between the stability of the UAVs and the performance of the power system; third, the cost on pyrotechnics including gunpowder is high, the safety requirement on daily storage and transportation of the pyrotechnics is high, many safety problems in civil applications would arise, and a series of problems, such as restriction on obtaining qualification for usage of pyrotechnics, would arise as well.

The above inherent disadvantages limit the popularization and development of the prior art in which the UVAs are adopted to carry the fire extinguishing bombs. Therefore, it is urgent to invent a fire extinguishing bomb which is safe and non-toxic, has low-cost, and does not have recoil or secondary fire risk.

### SUMMARY

To solve the above technical problems in the prior art, the present invention aims to provide a fire extinguishing bomb.

The present invention provides a fire extinguishing bomb, including a fire extinguishing part and a propelling part connected to each other;

wherein, the propelling part includes a storage bunker filled with a liquid or a fire extinguishing agent;

the liquid or the fire extinguishing agent is driven by compressing a volume of the storage bunker or compressing a volume of the liquid or the fire extinguishing agent and thus is sprayed out of the propelling part through a spray nozzle of the storage bunker, so that the fire extinguishing bomb obtains forward propulsion.

Preferably, the propelling part includes an expansion part, wherein the expansion part includes a power source component and a piston;

the power source component includes any one of the following components:

a potential energy power component, wherein the potential energy power component is configured to drive the piston to compress the volume of the storage bunker or directly compress the volume of the liquid or the fire extinguishing agent by releasing potential energy; a compressed gas source component is preferably adopted as the potential energy power component; and

an energy-induced deformation component, wherein the energy-induced deformation component is configured to drive the piston to compress the volume of the storage bunker or directly compress the volume of the liquid or fire extinguishing agent by generating an expansion deformation through an energy; a civil small gas generator such as an airbag generator for automobile is adopted as the energy-induced deformation component.

Preferably, the energy-induced deformation component generates the energy chemically or physically, and the potential energy power component employs any one of the following components:

a compressed gas source component;

an elastic component; and

a magnetic component;

wherein, after being expanded, a high pressure gas generated by the compressed gas source component pushes the piston to compress the volume of the storage bunker or directly compress the volume of the liquid or fire extinguishing agent, thus allowing a gas in the compressed gas source component to enter the storage bunker via an exhaust channel; and the piston is pushed to compress the volume of the storage bunker or directly compress the volume of the liquid or fire extinguishing agent by an elastic potential energy of the elastic component or a magnetic force of the magnetic component.

Preferably, the fire extinguishing part and the propelling part are detachably connected or fixedly connected; and

the fire extinguishing part, the propelling part, a mounting part and a tail wing together constitute an aerodynamic layout structure.

Preferably, the fire extinguishing part includes a fuze, and the fire extinguishing part further includes:

one sensor, wherein an output end of the sensor is connected to a trigger end of the fuze; or

a plurality of sensors, wherein output ends of the plurality of sensors are connected in parallel to the trigger end of the fuze directly, or the output ends of the plurality of sensors are electrically connected to an electrical trigger end of the fuze through a logic gate circuit.

Preferably, the propelling part includes a delay trigger, and an output end of the delay trigger is connected to a trigger end of the propelling part and a trigger end of the fire extinguishing part.

Preferably, the fire extinguishing bomb further includes a mounting part, wherein, the mounting part is tightly and fixedly connected to the fire extinguishing part and/or the propelling part.

Preferably, the mounting part is located at a center of mass of the full fire extinguishing bomb; and

the mounting part, the fire extinguishing part, the propelling part and a tail wing constitute a full bomb structure; and a pressure center of the full bomb is behind a center of gravity of the full bomb and the full bomb has static stability when flying.

Preferably, a shell of the fire extinguishing part adopts a hollowed-out structure penetrating through both the inner wall and the outer wall of the shell.

The present invention further provides a launching system, including a launching platform and the fire extinguishing bomb mentioned above carried on the launching platform.

The present invention further provides a fire extinguishing bomb, including a fire extinguishing part and a propelling part connected to each other;

wherein, the propelling part includes a storage bunker filled with a liquid fire extinguishing agent; and

the liquid fire extinguishing agent is driven by a pressure generated by reducing the volume of the storage bunker and thus is sprayed out of the propelling part through a spray nozzle of the storage bunker, and the fire extinguishing bomb simultaneously obtains a forward propulsion.

Preferably, the propelling part includes an expansion part, wherein the expansion part includes a power source component and a piston;

the power source component includes any one of the following components:

a potential energy power component, wherein the potential energy power component is configured to drive the piston to compress the volume of the storage bunker by releasing an elastic potential energy; and

an energy-induced deformation component, wherein the energy-induced deformation component is configured to drive the piston to compress the volume of the storage bunker by absorbing an energy and then a generating deformation.

Preferably, the potential energy power component employs any one of the following components:

a compressed gas source component;

an elastic component; and

a magnetic component;

wherein, the compressed gas source component is capable of generating an exhaust channel after being expanded, and thus allowing a gas in the compressed gas source component to enter the storage bunker via the exhaust channel.

Preferably, the fire extinguishing part and the propelling part are detachably connected or fixedly connected;

the fire extinguishing part and the propelling part are connected to each other to constitute an aerodynamic layout structure.

Preferably, the fire extinguishing part includes a fuze, and the fire extinguishing part further includes:

one sensor, wherein an output end of the sensor is electrically connected to an electrical trigger end of the fuze; or

a plurality of sensors, wherein output ends of the plurality of sensors are electrically connected in parallel to the electrical trigger end of the fuze directly, or the output ends of the plurality of sensors are electrically connected to the electrical trigger end of the fuze through a logic gate circuit.

Preferably, the propelling part includes a delay trigger, and an output end of the delay trigger is connected to a trigger end of the power source component.

Preferably, the fire extinguishing bomb further includes a mounting part, the mounting part is tightly and fixedly connected to the fire extinguishing part and/or the propelling part.

Preferably, the mounting part is located at a center of mass of a structure formed by the fire extinguishing part and the propelling part;

the mounting part, the fire extinguishing part and the propelling part constitute a full bomb structure; and a center of gravity of the full bomb structure is closer to a nose of the full bomb structure than a tail of the full bomb structure.

Preferably, a shell of the fire extinguishing part is provided with a hollowed-out structure penetrating through both the inner wall and the outer wall of the shell.

The present invention further provides a launching system, including a launching platform, and the fire extinguishing bomb mentioned above carried on the launching platform.

Compared with the prior art, the present invention has the following advantages:

1. After aerial carrier for the fire extinguishing bomb provided by the present invention aims a target in the air and drops the bomb through gravity, the fire extinguishing bomb is pushed to a fire source by a water propelling device in the bomb, and a fire extinguishing component is triggered by a delay fuze or a temperature sensitive fuze to perform the fire extinguishing operation. The fire extinguishing bomb has advantages of no secondary fire source risk, no recoil, no pollution and low cost, and thus it can be widely applied to fire extinguishing operations in various urgent, difficult and dangerous situations, especially to fire extinguishing operations through UAVs in urban high-rise buildings.

2. The fire extinguishing bomb provided by the present invention adopts water instead of gunpowder to propel, thereby reducing the risk that the fire extinguishing bomb becomes a secondary fire source.

3. The power source component used in the fire extinguishing bomb according to the present invention may be a civil small gas generator or a high pressure gas cylinder, such as an airbag generator for automobile, so that the cost is much lower than that of pyrotechnics such as gunpowder, the safety for storage, transportation and daily usage is also greatly increased, and there is no need to obtain qualification related to pyrotechnics, which is convenient for promotion and application of the present invention.

4. The fire extinguishing bomb according to the present invention is ignited in the air after falling due to gravity, which can greatly reduce the impact and interference to the UAV, and thus ensuring the safety and controllability of the UAV.

5. The fire extinguishing bomb provided by the present invention adopts technologies such as water propelling, a static and stable bomb body structure design, delayed triggering, aerial dropping and launching, and aerodynamic shape optimization, etc.

### BRIEF DESCRIPTION OF THE DRAWING

Other features, objects, and advantages of the present invention will become more apparent, upon reading the detailed description of the non-limiting embodiments with reference to the following drawing.

FIGURE is a schematic diagram showing the structure of the fire extinguishing bomb according to the present invention.

In the FIGURE:
Bomb body structure 1
Front bomb body 11
Rear bomb Body 12
Hanger 13
Tail wing stabilizer device 14
Fire extinguishing part 2
Shell 21
Fuze 22
Explosive material 23
Fire extinguishing agent 24
Propelling part 3
Power source component 31
Piston 32
Water chamber 33
Delay trigger 4

### DETAILED DESCRIPTION OF THE EMBODIMENTS

The present invention is described in detail hereinafter with reference to specific embodiments. The following embodiments are described for facilitating those skilled in the art to further understand the present invention, but do not intend to limit the present invention in any way. It should be noted that, for those having ordinary skill in the art, several variations and improvements can be made without departing from the concept of the present invention, all of which shall fall within the scope of protection of the present invention.

Firstly, a basic embodiment of the present invention is described below.

The present invention provides a fire extinguishing bomb, including a fire extinguishing part and a propelling part connected to each other; wherein, the propelling part includes a storage bunker filled with a liquid fire extinguishing agent; the liquid fire extinguishing agent is capable of being propelled by a pressure generated by reducing the volume of the storage bunker, so as to be sprayed out of the propelling part through a spray nozzle of the storage bunker, and the fire extinguishing bomb simultaneously obtains forward propulsion.

Specifically, the fire extinguishing part may be a fire extinguishing part of the existing fire extinguishing bomb, or may also be implemented according to the method as described in the following embodiments. The liquid fire extinguishing agent may be water, aqueous solution and other liquid; alternatively, the liquid fire extinguishing agent may also be a water-based fire extinguishing agent and other fire extinguishing agent. The spray nozzle may employ a one-way valve or may employ a membrane that will be destroyed after being pressed.

More specifically, the fire extinguishing part and the propelling part are connected to each other to form the bomb body structure 1. The water propelled fire extinguishing bomb may obtain forward propulsion through the propelling part 3, and the propelling part 3 is timely triggered by the delay trigger 4 to start propelling by ejecting water. The fire extinguishing part and the propelling part form the front bomb body 11 and the rear bomb body 12, respectively. The front bomb body 11 is tightly and fixedly connected to one end of the rear bomb body 12 through a connecting member.

Preferred embodiments according to the basic embodiment of the present invention are described below.

The propelling part includes an expansion part, wherein the expansion part includes a power source component and a piston. The power source component includes any of the following components: a potential energy power component, wherein the potential energy power component is configured to drive the piston to compress the volume of the storage bunker or to directly compress the volume of the liquid or fire extinguishing agent by releasing potential energy, such as elastic potential energy; and an energy-induced deformation component, wherein the energy-induced deformation component is configured to drive the piston 32 to compress the volume of the storage bunker by generating expansion deformation through energy change, such as energy absorption. The potential energy power component employs any one of the following components: a compressed gas source component, an elastic component and a magnetic component. After being expanded, the high pressure gas generated by the compressed gas source component pushes the piston to compress the volume of the storage bunker or to directly compress the volume of the liquid or fire extinguishing agent, for example, the compressed gas source component after being expanded allows the gas therein to enter the storage bunker via an exhaust channel. The piston is pushed to compress the volume of the storage bunker or to directly compress the volume of the liquid or fire extinguishing agent by elastic potential energy of the elastic component or magnetic force of the magnetic component.

Specifically, the elastic component may be a spring, a reed, a torsion spring, a rubber block and the like. wherein the elastic component obtains elastic potential energy when it is in a compressed state or obtains elastic potential energy when it is in a stretched state. The magnetic component may be a permanent magnet, an electromagnet and the like. The energy-induced deformation component may be a component that deforms by physical or chemical expansion, such as a chemical energy-induced deformation component, an electro-induced deformation component, a thermal-induced deformation component, a photo-induced deformation component, a magnetism-induced deformation component, or a humidity-induced deformation component.

More specifically, as shown in FIGURE, the illustration in FIGURE is taken as an example, and more specifically, the compressed gas source component is taken as an example. For example, the compressed gas source component includes the power source component 31, the piston 32, and the water chamber 33 that is formed by the storage bunker. The power source component 31, the piston 32 and the water chamber 33 are arranged in sequence in a direction from the nose of the bomb to the tail of the bomb. The piston 32 is configured to separate the power source component 31 from the water in the water chamber 33 to ensure that the propelling part 3 could still work normally when the bomb body (i.e., the fire extinguishing bomb) is upside down as falling down. The water chamber 33 is configured to store water by means of a water bag made of plastic film. The power source component 31 is preferably any one of the following: a gas generator, a high pressure gas cylinder, or an airbag generator for automobile. The fuze 22 includes, but is not limited to, any one of a gunpowder fuze, a collision fuze or a thermal sensitive fuze, thereby ensuring daily safety and reliable triggering. When the explosive material 23 explodes, the high pressure gas is generated, and the fire extinguishing agent 24 is sprayed out to extinguish the fire. Both the explosive material 23 and the power source component 31 employs a gas generating agent which is non-toxic and harmless, and has low combustion temperature and low sensitivity. The piston 32 is provided with a through hole to form an exhaust channel. On the premise of ensuring the smooth movement of the piston, the pressure of a high pressure gas chamber (i.e., the pressure applied on a wall surface of the power source component 31) is released appropriately through the exhaust channel (i.e., the through hole); meanwhile, water is driven by the released gas to be sprayed out at a high speed, thereby propelling the fire extinguishing bomb to move. The power source component 31 includes a high pressure gas source.

The fire extinguishing part and the propelling part are detachably or fixedly connected to each other; and the fire extinguishing part, the propelling part, a mounting part and a tail wing together constitute an aerodynamic layout structure.

Specifically, the aerodynamic layout structure includes an air deflector, a tail wing, and a streamlined shell. As shown in FIGURE, the aerodynamic layout structure includes the tail wing stabilizer device 14; the other end of the rear bomb body 12 is tightly and fixedly connected to the tail wing stabilizer device 14. The tail wing stabilizing device 14 is arranged at the tail of the fire extinguishing bomb, and is configured to adjust the pneumatic pressure center of the full bomb (i.e., the fire extinguishing bomb), so as to ensure the static stability of the full bomb, and thus ensuring the accuracy of spread of the falling points.

The fire extinguishing part includes a fuze, and the fire extinguishing part further includes: a sensor, wherein an output end of the sensor is connected to a trigger end of the fuze, for example, the output end of the sensor is electrically connected to an electrical trigger end of the fuze; or a plurality of sensors, wherein output ends of the plurality of sensors are connected in parallel to the trigger end of the fuze directly, for example, the output ends of the plurality of sensors are electrically connected in parallel to the electrical trigger end of the fuze directly, or the output ends of the plurality of sensors are electrically connected to the electrical trigger end of the fuze through a logic gate circuit.

Specifically, the output ends of the plurality of sensors are connected in parallel to the trigger end of the fuze directly, so that any one of the sensors can trigger the fuze independently; the output ends of the plurality of sensors are electrically connected to the electrical trigger end of the fuze through a logic gate circuit, so that logic control can be realized in which the fuze is triggered by one of output levels of the plurality of sensors or a combination of several output levels of the plurality of sensors.

More specifically, as shown in FIGURE, the fire extinguishing part 2 includes the shell 21, the fuze 22, the explosive material 23 and the fire extinguishing agent 24. The fuze 22, the explosive material 23 and the fire extinguishing agent 24 are all provided inside the shell 21. The fuse 22 is connected to the explosive material 23; and the fire extinguishing agent 24 is arranged around the explosive material 23. The sensor may be an acceleration sensor or a temperature sensor. The acceleration sensor is provided in the front bomb body 11 of the bomb body structure 1; and the temperature sensor is provided outside the fire extinguishing part 2.

The propelling part includes a delay trigger, and an output end of the delay trigger is connected to the trigger end of the fuze of the power source component and the trigger end of the fuze of the fire extinguishing part.

Specifically, as shown in FIGURE, when the fire extinguishing bomb is separated from the unmanned aircraft vehicle, the delay trigger 4 starts timing. After the fire extinguishing bomb falls in the air for a certain time, specifically, when the delayed time reaches a preset time, that is, when the distance between the fire extinguishing bomb and the unmanned aircraft vehicle reaches a safe launching range, a trigger procedure is started: the delay trigger 4 triggers the power source component 31 of the propelling part 3 to start working, and the power source component 31 causes the piston 32 to drive the water in the water chamber 33 to be sprayed out.

The fire extinguishing bomb includes a mounting part, and the mounting part is tightly and fixedly connected to the fire extinguishing part and/or the propelling part. The mounting part is located at the center of mass of the full bomb; for example, the mounting part is located at the center of mass of the structure formed by the fire extinguishing part and the propelling part. The mounting part, the fire extinguishing part, the propelling part and the tail wing constitute a full bomb structure. The pressure center of the full bomb is behind the center of gravity of the full bomb, and the full bomb has static stability when flying. For example, the center of gravity of the full bomb structure is closer to the nose of the full bomb structure relatively to the tail of the full bomb structure.

Specifically, as shown in FIGURE, the mounting part includes the hanger 13, and the fire extinguishing bomb is connected to the unmanned aerial vehicle through the hanger 13. Preferably, the fire extinguishing bomb is hung by the hanger on a launching platform under the unmanned aerial vehicle, and the hanger is sleeved on the bomb body structure 1 through a threaded ring. The hanger 13 can move through thread adjustment to be adjacent to the center of mass of the fire extinguishing bomb, so as to ensure that the disturbance to the attitude control of the bomb body is minimized after the bomb is dropped in the air due to gravity.

The shell of the fire extinguishing part adopts a hollowed-out structure penetrating through both the inner wall and the outer wall of the shell.

Specifically, as shown in FIGURE, a spindle-shaped fairing is arranged at the front end of the bomb body structure 1; the bomb body structure 1 is provided with a hollowed-out structure, so as to ensure integrity of the bomb body structure 1 and facilitate explosion, and to ensure that the fire extinguishing agent 24 in the fire extinguishing part 2 is smoothly sprayed out, and thus effectively extinguishing the fire. When the hollowed-out structure is designed, the following shall be taken into consideration: the hollowed-out structure can withstand the high pressure gas, that is, the hollowed-out structure can the internal pressure of the high pressure gas generated when the explosive material 23 is detonated. Thus, a suitable material should be selected when the wall thickness is designed according to a designed pressure intensity peak.

The present invention provides a launching system, which includes a launching platform and the fire extinguishing bomb carried on the launching platform.

Specifically, the launching platform may be an aerial platform, a land-based platform, or a sea-based platform. The aerial platform may be a manned or unmanned aerial vehicle, the land-based platform may be a fire truck or a building, and the sea-based platform may be a fire boat or an oil drilling platform.

The working principle of the present invention is further explained as below:

After adjusting the attitude and aiming at a target, the unmanned aircraft vehicle drops the fire extinguishing bomb due to gravity. At this time, when the hanger 13 is separated from the unmanned aircraft vehicle, the delay trigger 4 starts timing. After the fire extinguishing bomb falls in the air for a certain time, specifically, when the delayed time reaches a preset time, that is, when the distance between the fire extinguishing bomb and the unmanned aircraft vehicle reaches a safe launching range, a trigger procedure is started: the delay trigger 4 triggers the power source component 31 of the propelling part 3 to start working, and the power source component 31 causes the piston 32 to drive the water in the water chamber 33 to be sprayed out. Specifically, the power source component 31 pushes the piston 32 to move to squeeze the water in the water chamber 33 to spray out at a high speed, so that the fire extinguishing bomb obtains forward propulsion and flies to the fire source accordingly. Meanwhile, the delay trigger 4 triggers the fire extinguishing part 2, and after entering into the range of the fire source, the delay trigger 4 forcibly triggers the fire extinguishing part 2 to spray the fire extinguishing agent 24.

Specifically, when the fire extinguishing bomb collides with the target, a certain negative acceleration is generated. At this time, when the acceleration sensor detects that the value of the negative acceleration is greater than a preset threshold thereof, the temperature sensor is turned on and starts detecting the ambient temperature. When the ambient temperature exceeds a preset temperature threshold, the explosive material 23 is detonated by the fuze 22, and thus the extinguishing agent 24 is sprayed out to perform fire extinguishing operation on the fire source. If the ambient temperature detected by the temperature sensor is less than or equal to the preset temperature threshold, the fuze 22 will re-enter a safe state.

The specific embodiments of the present invention have been described above. It should be understood that the present invention is not limited to the above specific embodiments, and those skilled in the art may make various variations or modifications within the scope of the appended claims, which does not affect the essence of the present invention. In the case of no conflict, the embodiments of the present invention can be arbitrarily combined with each other and the features in the embodiments can be arbitrarily combined with each other.

What is claimed is:

1. A fire extinguishing bomb, comprising a fire extinguishing part and a propelling part wherein the fire extinguishing part and the propelling part are connected to each other;
the propelling part comprises a storage bunker filled with a liquid or a fire extinguishing agent;
the liquid or the fire extinguishing agent is driven by compressing a volume of the storage bunker or compressing a volume of the liquid or a volume of the fire extinguishing agent, and thus the liquid or the fire extinguishing agent is sprayed out of the propelling part through a spray nozzle of the storage bunker to propel the fire extinguishing bomb forward.

2. The fire extinguishing bomb of claim 1, wherein the propelling part comprises an expansion part, wherein the expansion part comprises a power source component and a piston;
the power source component comprises one selected from the group consisting of:
a potential energy power component, wherein the potential energy power component is configured to drive the piston to compress the volume of the storage bunker or directly compress the volume of the liquid or the volume of the fire extinguishing agent by releasing a potential energy; and
an energy-induced deformation component, wherein the energy-induced deformation component is configured to drive the piston to compress the volume of the storage bunker or directly compress the volume of the liquid or the volume of the fire extinguishing agent by generating an expansion deformation through an energy; a civil small gas generator is adopted as the energy-induced deformation component.

3. The fire extinguishing bomb of claim 2, wherein the energy-induced deformation component generates the energy chemically or physically, and the potential energy power component employs one selected from the group consisting of:
a compressed gas source component;
an elastic component; and
a magnetic component;
wherein, when the potential energy power component is the compressed gas source component, after a high pressure gas generated by the compressed gas source component is expanded, the high pressure gas pushes the piston to compress the volume of the storage bunker or directly compress the volume of the liquid or the volume of the fire extinguishing agent, a gas in the compressed gas source component enters the storage bunker via an exhaust channel; when the potential energy power component is the elastic component, the piston is pushed to compress the volume of the storage bunker or directly compress the volume of the liquid or the volume of the fire extinguishing agent by an elastic potential energy of the elastic component; or when the potential energy power component is the magnetic component, the piston is pushed to compress the volume of the storage bunker or directly compress the volume of the liquid or the volume of the fire extinguishing agent by a magnetic force of the magnetic component.

4. The fire extinguishing bomb of claim 2, wherein, the fire extinguishing part and the propelling part are detachably connected or fixedly connected; and
the fire extinguishing part, the propelling part, a mounting part and a tail wing together constitute an aerodynamic layout structure.

5. The fire extinguishing bomb of claim 1, wherein the fire extinguishing part includes a fuze and at least one sensor,
when the at least one sensor comprises one sensor, an output end of the sensor is connected to a trigger end of the fuze; and
when the at least one sensor comprises a plurality of sensors, output ends of the plurality of sensors are connected in parallel to the trigger end of the fuze directly, or the output ends of the plurality of sensors are electrically connected to an electrical trigger end of the fuze through a logic gate circuit.

6. The fire extinguishing bomb of claim 2, wherein the propelling part comprises a delay trigger, and an output end of the delay trigger is connected to a trigger end of the propelling part and a trigger end of the fire extinguishing part.

7. The fire extinguishing bomb of claim 1, further comprising a mounting part, wherein, the mounting part is tightly and fixedly connected to the fire extinguishing part and/or the propelling part.

8. The fire extinguishing bomb of claim 7, wherein the mounting part is located at a center of mass of the fire extinguishing bomb;
the mounting part, the fire extinguishing part, the propelling part and a tail wing constitute a structure of the fire extinguishing bomb; and a pressure center of the fire extinguishing bomb is behind a center of gravity of the fire extinguishing bomb and the fire extinguishing bomb has static stability when flying.

9. The fire extinguishing bomb of claim 1, wherein a shell of the fire extinguishing part adopts a hollowed-out structure penetrating through both an inner wall and an outer wall of the shell.

10. A launching system, comprising a launching platform and the fire extinguishing bomb of claim 1 carried on the launching platform.

11. A fire extinguishing bomb, comprising a fire extinguishing part and a propelling part; wherein the fire extinguishing part and the propelling part are connected to each other;
wherein, the propelling part comprises a storage bunker filled with a liquid fire extinguishing agent; and
the liquid fire extinguishing agent is driven by a pressure generated by reducing a volume of the storage bunker and thus the liquid fire extinguishing agent is sprayed out of the propelling part through a spray nozzle of the storage bunker, and the fire extinguishing bomb simultaneously obtains a forward propulsion.

12. The fire extinguishing bomb of claim 11, wherein the propelling part comprises an expansion part, wherein the expansion part comprises a power source component and a piston;
the power source component comprises one selected from the group consisting of:
a potential energy power component, wherein the potential energy power component is configured to drive the piston to compress the volume of the storage bunker by releasing an elastic potential energy; and
an energy-induced deformation component, wherein the energy-induced deformation component is configured to drive the piston to compress the volume of the storage bunker by absorbing an energy and then generating a deformation.

13. The fire extinguishing bomb of claim 12, wherein the potential energy power component employs one selected from the group consisting of:
a compressed gas source component;
an elastic component; and
a magnetic component;
wherein, when the potential energy power component is the compressed gas source component, the compressed gas source component is expanded to generate an exhaust channel, and a gas in the compressed gas source component enters the storage bunker via the exhaust channel.

14. The fire extinguishing bomb of claim 12, wherein, the fire extinguishing part and the propelling part are detachably connected or fixedly connected;
the fire extinguishing part and the propelling part are connected to each other to constitute an aerodynamic layout structure.

15. The fire extinguishing bomb of claim 11, wherein the fire extinguishing part comprises a fuze and at least one sensor,
when the at least one sensor comprises one sensor, an output end of the sensor is electrically connected to an electrical trigger end of the fuze; and
when the at least one sensor comprises a plurality of sensors, output ends of the plurality of sensors are electrically connected in parallel to the electrical trigger end of the fuze directly, or the output ends of the plurality of sensors are electrically connected to the electrical trigger end of the fuze through a logic gate circuit.

16. The fire extinguishing bomb of claim 12, wherein the propelling part comprises a delay trigger, and an output end of the delay trigger is connected to a trigger end of the power source component.

17. The fire extinguishing bomb of claim 11, further comprising a mounting part, the mounting part is tightly and fixedly connected to the fire extinguishing part and/or the propelling part.

18. The fire extinguishing bomb of claim 17, wherein the mounting part is located at a center of mass of a structure formed by the fire extinguishing part and the propelling part;
the mounting part, the fire extinguishing part and the propelling part constitute a full bomb structure; and a center of gravity of the full bomb structure is closer to a nose of the full bomb structure than a tail of the full bomb structure.

19. The fire extinguishing bomb of claim 11, wherein a shell of the fire extinguishing part is provided with a hollowed-out structure penetrating through both an inner wall and an outer wall of the shell.

20. (canceled)
